(19) United States
(12) Patent Application Publication
(10) Pub. No.: US 2015/0363790 A1
(43) Pub. Date: Dec. 17, 2015

(54) Asset tracking and counterfeit detection system

(71) Applicants: Peter Collins, Portsmith, RI (US); David Collins, Duxbury, MA (US)

(72) Inventors: Peter Collins, Portsmith, RI (US); David Collins, Duxbury, MA (US)

(21) Appl. No.: 14/120,648

(22) Filed: Jun. 13, 2014

(51) Int. Cl. G06Q 30/00; G06K 19/02; G06K 7/00

(52) U.S. Cl. CPC G06Q 30/0185; G06K 7/00; G06K 19/02

(57) ABSTRACT

A system that combines covert taggants with a cloud based IUID tag tracking system to protect items form counterfeiting, piracy, and diversion.

### CROSS REFERENCE TO RELATED APPLICATIONS

This application is a continuation in part of pending U.S. patent application Ser. No. 13/573,396 ('396) filed Sep. 13, 2012 entitled Secure Asset Tracking System, which claims priority of provisional application No. 61/686,060, filed Mar. 30 2012 which are herein incorporated by reference in their entirety.

### FIELD OF THE INVENTION

This invention relates to a system to track assets as they move from a point of origin to end-users and to provide ready identification of assets that are counterfeit.

### BACKGROUND OF THE INVENTION

Asset tracking and authentication at the item level is known and used in the prior art. Covert and overt technologies are each known and used. Covert technologies use taggants, including forensic techniques such as the introduction of synthetic or botanical DNA into or on an asset. Covert techniques also include IR-sensitive taggants that confirm item authenticity when exposed to an alternative light source.

Overt technologies include generating a unique identifier for each individual asset (item unique identifier “IUID”); encoding the IUID in a machine-readable form, such as a scan-able 2-dimentional bar code; and attaching the code to an asset.

In general, taggant technologies are difficult to reproduce and therefore provide a means to identify an asset that is a counterfeit. At the same time, it is not practical use a taggant as to uniquely identify each asset and the more difficult a taggant is to reproduce by a forger, the more difficult it is to decode so that the cost and time involved in decoding a robust taggant make it impractical to decode it on a routine basis.

IUID tags allow each asset to be uniquely identified and its identifying information to be stored in a cloud-based database. Each time the asset is transferred, the tag can be scanned and the time and location of shipment and the time and location of receipt can be stored with the identifying information in the database. This allows each item to be tracked, in order to detect anomalies in an item's track indicating a possible diversion of an item or that an item is a counterfeit.

The '396 application teaches the use of heuristic, expert database analytics to build a predictive tracking model for tag items in the cloud database. These computer-generated models provide a base line from which deviations can be detected.

An asset with an IUID tag is easy to scan and therefore easy to track. Using this tracking information, diversion of the asset can be detected and the introduction of forged or unauthorized products in to the supply channel can be detected. But the ability to detect forgeries is through inference and also dependent upon reliable scanning of the tags in the field, so the possibility of an erroneous flags indicating possible forgery or deviation is high, and potentially costly to resolve.

### SUMMARY OF THE INVENTION

An object of this invention is the provision of a system that combines covert taggants with a cloud based IUID tag tracking system to protect items from counterfeiting, piracy, and diversion. More particularly, such a system using expert database analytics to build a predictive IUD tracking model to flag assets that deviate from the model and, in response to a flag, decodes the covert taggant to directly establish forgery.

Briefly, this invention contemplates a method that combines a unique scan-able tag and a taggant affixed to or other wise physically associated with each asset. An overt IUID scan-able code on each item is registered in an Internet accessible database. Expert database analytics builds a predictive IUD tracking model and flag assets that deviate from the model. In response to a flag, the method decodes the covert taggant to directly establish forgery.

### BRIEF DESCRIPTION OF THE DRAWINGS

The subject matter that is regarded as the invention is particularly pointed out and distinctly claimed in the claims at the conclusion of the specification. The forgoing and other objects, features, and advantages of the invention are apparent from the following detailed description taken in conjunction with the accompanying drawings in which:

FIG. 1 is a representation of an asset with an overt IUID tag and a covert taggant in accordance with the teachings of this invention.

FIG. 2 is a system block diagram of components to carry out the steps of the invention.

FIG. 3 is a flow diagram illustrating the invention as it tracks items by scanning an IUID tag on each item, compares the track with predictive tracking model, and flag assets that deviate from the model.

FIG. 4 is a flow diagram of the steps in response to a flag.

### DETAILED DESCRIPTION OF THE INVENTION

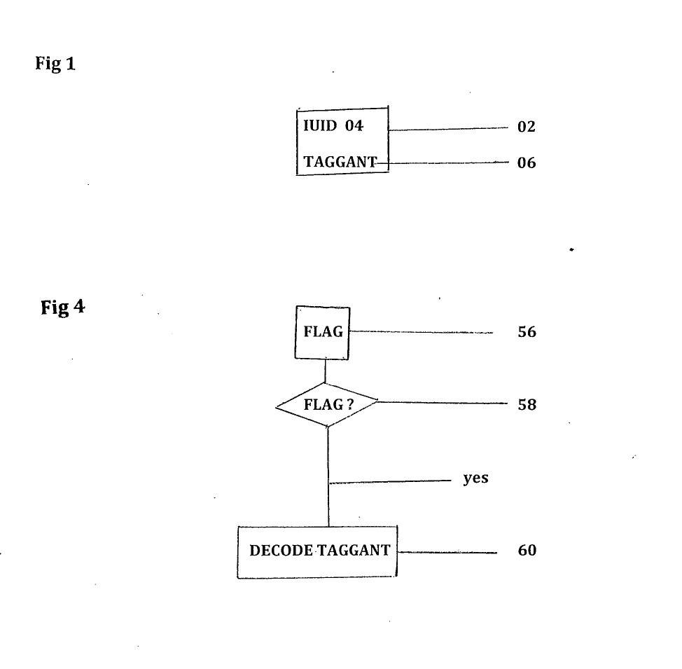

Referring now to FIG. 1, in accordance with the teachings of this invention, an asset 02 is provided with an overt IUID tag 04 and a covert taggant 06. The IUID tag 04 can use any suitable commercially available scan-able technology, such as a 2-dimentional bar code tag or an RFID tag, for example. The data encoded in the tag 04 will typically include the original manufacturer or original supplier data along with a serial number that is different for each asset 02 and uniquely identifies each item. The taggant 06 can use any suitable commercially available taggant technology, preferably, DNA encoded data. The taggant 06, cannot be easily duplicated, and therefore can be used to positively identify a forgery. As a practical matter, the taggant does not uniquely identify an asset and is decoded each time an asset moves

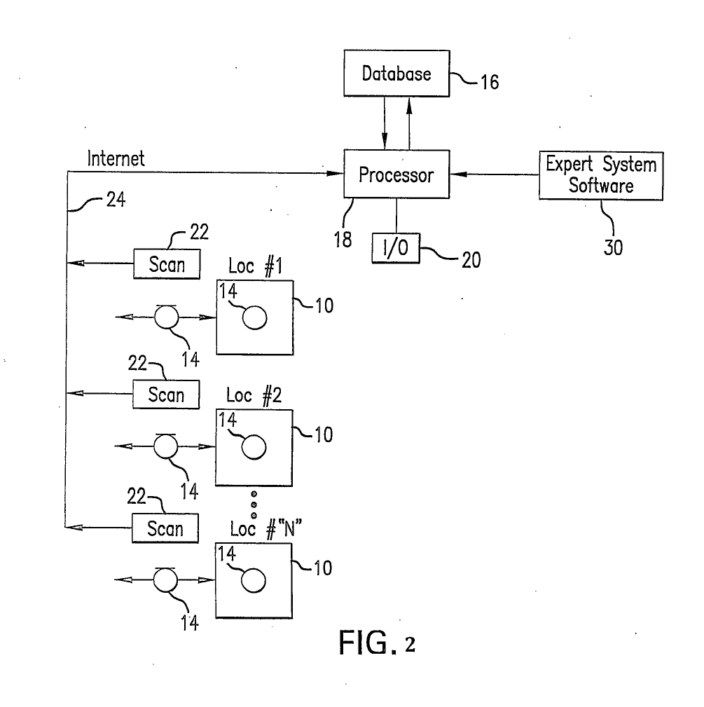

FIG. 2 is a system block diagram of the components to carry out the steps of the invention. These are the same components as shown and described in the above referenced copending '396 application, and described in greater detail in that application. The blocks with the reference number 10 illustrate locations within the enterprise where assets are located and moved into and out of For the purpose of illustrating the invention, locations numbered 1, 2 and N are shown in the drawing. Some are assumed to have been part of the system for a considerable period of time, and others are assumed to have been newly or recently added as part of the system. Circle 14 at each location 10 represents a large number of different assets. Although not necessarily the situation at every location, some of the assets have been part of the system for a period of time, and some of the assets are new or recently added to the system.

As explained in connection with FIG. 1, each asset, and its critical embedded components, has a unique identifier tag or mark 04. This tag is registered in a cloud-hosted database 16 via a processor 18. Each asset also carries a taggant 06. Typically, the taggant 06 will encode a class of assets, not each individual asset. As will be appreciated by those skilled in the art, while each tag 04 is unique to the tagged asset, the tag also points to data in the database 16 that allows the asset to be classified with the same assets and similar assets. In addition to the data encoded on the tag, the database includes other information linked in the database to the asset's class. This additional information is inputted into the database with a relational tie to the asset and/or asset class and can be used by the expert system in flagging an anomalous incident in the movement and/or location of the asset. This additional information may include, for example, an assessment of the venerability of the class of assets to so-called malware or to substitution of unauthorized part replacement and to an expected frequency with which a class of assets is moved. It advantageously includes also an assessment of the locations. Also included is a feedback input/output mechanism 20 that allows update inputs to the database of information that can be used in the expert system analysis, such as actual incidents of an asset being infected with malware or repaired with unauthorized parts.

Data about each asset as it moves out from and into a location 10 (indicated by the arrows) is read by scanning input device 22 and coupled to the database 16 via the processor 18 and the Internet 24. The input device 22 includes a scanner that reads the tag data and also provides GPS verified asset location data, repair sub-location(s), event time stamp data, personal identity data, and repair/alteration step(s) performed. This data flowing from the tracking input device is transmitted via an Internet link 24 to the cloud-hosted processor 18 and database 16. The data is processed using Big Data Analytics techniques and/or additional artificial intelligence expert system software programs 30 to determine the probably of a deviation from a normative established by the expert system based on the data collected from a large number of the same or similar transactions with the same or similar assets.

It will be appreciated that over even a short period of time, that database will have stored in it data from an enormous number of asset movements from one location to another and usually back. The cloud-based processor 18, using the expert system software 30, classifies the data from previous asset movements into a data set that matches as closely as practical the data for each new movement. The criteria include the same and/or similar assets with the same and/or similar locations, asset repair/alteration, etc. The processor, using the expert system software, then generates a probable range for the data from each successive input from device 22 as the asset moves from one location to another. If the new data falls outside of the range by an unacceptable amount, the processor generates a flag output indicating the asset should be inspected.

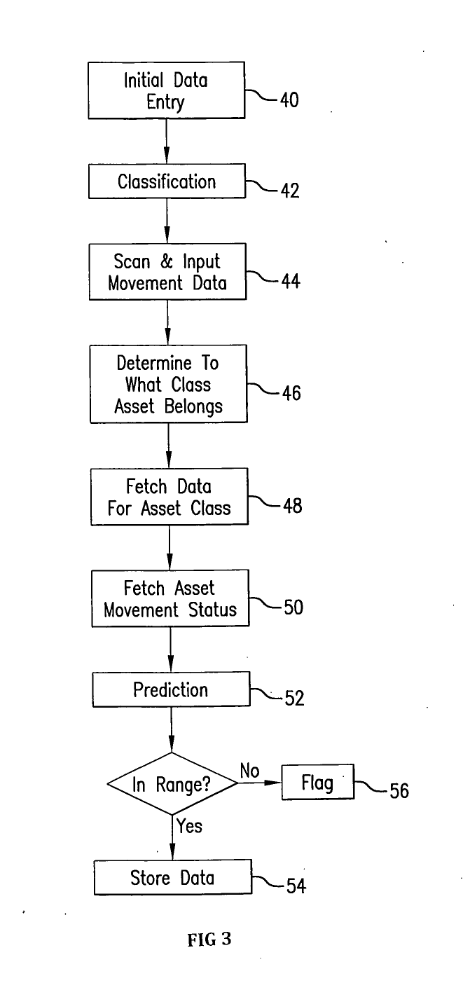

FIG. 3 outlines the steps in the practice of the invention in order to generate a flag. In an initial data entry step 40, the unique tag 04 data each asset with its location history is entered into the database 16. In certain circumstance, taggant 06 data is also entered into the database. In an initial classification step 42, the expert software using, for example, Big Data Analytics classifies each asset. For example, an asset included in a class where they are the same type (or similar types where the same type class has two few members) and in a class for same type assets in the same location. Step 44 scans and inputs data associated with the movement of each asset. Step 46 determines the class to which the moved asset belongs. Step 48 fetches the stored data for previous movements of this class of assets. The processor fetches from the database the movement status of the asset, step 50. A suitable expert system program is used to process the stored data for the class of assets and make a prediction of the expected parameters for the asset at this stage in its movement, step 52. For example, based on the stored data for the class to a given point at which there is a new input from an asset, the expert system can make a prediction using a Hidden Markov Models (HMMs) and related prototypical dependency models to predict a range in which the new input data should fall. If the new data falls within the predicted range, the new data is added to the stored movement as another data point, step 54. If the new data falls outside the range, the processor generates a “flag message” that is outputted to I/O terminal 20, step 56.

Assuming a forger has managed to forge the IUID code assigned to an asset, when the forged IUID tag 04 is scanned, the scanned data may match the data stored in the database for that asset. However, the expert system will detect and flag the scanned data as possibly generated by a forged tag. For example, the same data will have transmitted to the database when the authentic item was initially shipped and initially received. The next expected transmission of this data to the database, if any, would be from the site of the initial receipt of the asset, and would usually indicate a movement of the asset out of the site or a movement within the site.

The flag generated by the expert system in response to a forged tag 04 is inferential. Referring now to FIG. 4, in order to resolve this inference of forgery, in accordance with the teaching of this invention, the flag outputted in step 56 in response to a possible forgery is detected in step 58, and the taggant 06 is decoded in step 60, which provides a positive determination of whether or not the asset is a forgery.

It will appreciated that data is the key to creating a unique code that can be identified and traced. Layer machine-readable barcode encoding a unique item identifier data provides a element of control that follows an asset throughout its life cycle—from production through supply chain, during usage and finally at its disposal phase.

Additional unique serialized numbers can be added to the mark and can be human readable or invisible to the human eye and read only by fluoresce when exposed to UV light. This serialized code will uniquely identify the authentication authority's unique signature. Any inconsistency in the sequence or concentration of synthetic DNA or in registered item-unique data in the cloud at any checkpoint will trigger detection of a counterfeit or otherwise non-conforming asset.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

1. A method to establish authenticity of an asset, comprising in combination:
affixing an IUID tag to said asset, said tag encoding data that uniquely identifies said asset;
storing said data in an Internet accessible database;
affixing a taggant to said asset, taggant encoding data that establishes authenticity of said asset;
racking said asset by scanning said tag as said asset moves from one location and is received at another location;
storing data from said scanning step in said database;
comparing data derived from said tracking step with said data in said database to detect any anomaly between stored data and scanned data;
decoding said taggant in response to detection of an anomaly in said comparing step.

2. A method to establish authenticity of an asset, comprising in combination:
affixing an IUID tag to said asset, said tag encoding data that uniquely identifies said asset;
storing said data in an Internet accessible database;
affixing a synthetic DNA taggant to said asset, said DNA taggant encoding data that establishes authenticity of said asset;
tracking said asset by scanning said tag as said asset moves from one location and is received at another location;
storing data from said scanning step in said database;
comparing data derived from said scanning step with said data in said database;
detecting an anomaly in said movement based a departure between the movement of said asset determined in said tracking step and a heuristic predictive model of movement of said asset;
decoding said synthetic DNA taggant in response to detection of an anomaly in said comparing step.

3. A system to insure authenticity of an asset as in claim 1 wherein said scannable tag is a 2-dimentional bar code.

4. A system to insure authenticity of an asset as in claim 2 wherein said scannable tag is a 2-dimentional bar code.

5. A system to insure authenticity of an asset as in claim 1 wherein said forensic data is encoded in DNA.

6. A system to insure authenticity of an asset as in claim 2 wherein said forensic data is encoded in DNA.

7. A system to insure authenticity of an asset as in claim 3 wherein said forensic data is encoded in DNA.

8. A system to insure authenticity of an asset as in claim 4 wherein said forensic data is encoded in DNA.
